(19) United States
(12) Patent Application Publication
(10) Pub. No.: US 2026/0166982 A1
(43) Pub. Date: Jun. 18, 2026

(54) P2 HYBRID MODULE WITH K0 CLUTCH

(71) Applicant: Schaeffler Technologies AG & Co. KG, Herzogenaurach (DE)

(72) Inventors: Noah Kee, Rittman, OH (US); Maximilian Podschwadt, SALINE, MI (US)

(73) Assignee: Schaeffler Technologies AG & Co. KG, Herzogenaurach (DE)

(21) Appl. No.: 18/981,662

(22) Filed: Dec. 16, 2024

(51) Int. Cl. B60K 6/387; B60K 6/40; H02K 7/08; H02K 7/10; H02K 7/108

(52) U.S. Cl. CPC B60K 6/387; B60K 6/40; H02K 7/08; H02K 7/10; H02K 7/108; B60Y 2200/92; B60Y 2400/426

(57) ABSTRACT

A hybrid module includes an electric motor having a rotor, a torque converter with a cover rotatably connected to the rotor, a K0 shaft and a K0 clutch. The torque converter is arranged for driving engagement with an input shaft of a transmission and the K0 shaft is arranged for driving connection to a crankshaft of a combustion engine. The K0 clutch is arranged for selectively rotatably connecting the rotor to the K0 shaft, and includes a piston sealed to the cover at a radially inner portion and at a radially outer portion.

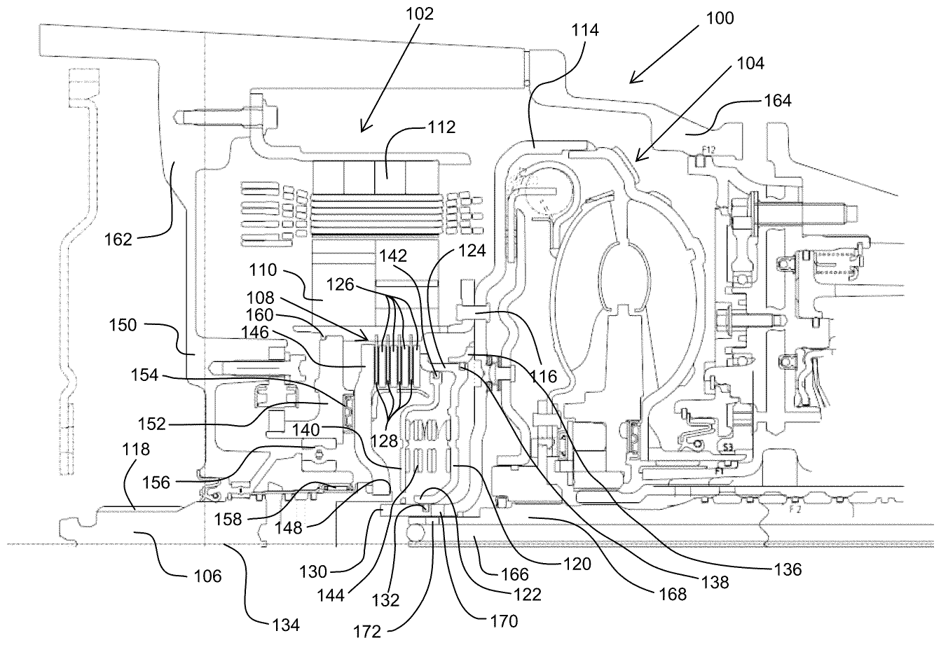

### TECHNICAL FIELD

The present disclosure relates generally to a P2 hybrid module, and more specifically to a P2 hybrid module with a K0 clutch.

### BACKGROUND

Hybrid modules are known. One example is shown and described in United States Patent Application Publication No. 2022/0032762 titled TORQUE TRANSMISSION APPARATUS FOR THE TRANSMISSION OF A TORQUE TO A TRANSMISSION OF A VEHICLE WHICH CAN BE DRIVEN BIA A HYBRID DRIVE to Simon.

### SUMMARY

Example embodiments broadly comprise a hybrid module including an electric motor having a rotor, a torque converter with a cover rotatably connected to the rotor, a K0 shaft and a K0 clutch. The torque converter is arranged for driving engagement with an input shaft of a transmission and the K0 shaft is arranged for driving connection to a crankshaft of a combustion engine. The K0 clutch is arranged for selectively rotatably connecting the rotor to the K0 shaft, and includes a piston sealed to the cover at a radially inner portion and at a radially outer portion.

In some example embodiments, the K0 clutch also includes a first plurality of clutch plates rotatably connected to the K0 shaft, and a second plurality of clutch plates rotatably connected to the rotor. The piston is arranged to compress the first plurality of clutch plates against the second plurality of clutch plates to engage the K0 clutch to rotatably connect the rotor to the K0 shaft. In some example embodiments, the cover has a tubular portion and the radially inner portion is sealed to the tubular portion. In an example embodiment, the tubular portion at least partially overlaps at least one of the second plurality of clutch plates in a radial direction. In an example embodiment, the tubular portion at least partially overlaps the K0 shaft in a radial direction.

In some example embodiments, the cover has a tubular projection and the radially outer portion is sealed to the projection. In an example embodiment, the tubular projection is secured to the cover by welding or riveting. In an example embodiment, the rotor is secured to the cover radially outside of the tubular projection. In an example embodiment, the tubular projection at least partially overlaps the first plurality of clutch plates and the second plurality of clutch plates in an axial direction.

In some example embodiments, the hybrid module also includes a compensation plate fixed to the cover, and the piston is sealed to the compensation plate. In an example embodiment, the hybrid module also includes a spring arranged axially between the compensation plate and the piston for urging the piston away from the compensation plate.

In some example embodiments, the hybrid module also includes a reaction plate fixed to the K0 shaft and arranged to restrict axial movement of the first plurality of clutch plates and the second plurality of clutch plates away from the piston. In some example embodiments, the hybrid module also includes a housing, a rotor flange fixed to the rotor and rotatably arranged in the housing, and a first bearing for rotatably supporting the reaction plate against the rotor flange. In an example embodiment, the first bearing is an axial needle bearing. In some example embodiments, the hybrid module also includes a second bearing for rotatably supporting the rotor flange in the housing. In an example embodiment, the second bearing is a ball bearing.

In some example embodiments, the hybrid module also includes a housing and a third bearing for rotatably supporting the K0 shaft in the housing. In an example embodiment, the third bearing is a radial needle bearing.

### BRIEF DESCRIPTION OF THE DRAWINGS

The single figure illustrates a top half cross-sectional view of a P2 hybrid module according to an example embodiment.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The following description is made with reference to the single figure. The single figure illustrates a top half cross-sectional view of P2 hybrid module 100 according to an example embodiment. Hybrid module 100 includes electric motor 102, torque converter 104, K0 shaft 106 and K0 clutch 108. Electric motor 102 includes rotor 110 and stator 112. Torque converter 104 is arranged for driving engagement with an input shaft of a transmission (not shown) and includes cover 114 rotatably connected to the rotor via rivets 116, for example. K0 shaft 106 is arranged for driving connection to a crankshaft of a combustion engine (not shown) via splined portion 118, for example.

K0 clutch 108 is arranged for selectively rotatably connecting the rotor to the K0 shaft. That is, when clutch 108 is engaged, the rotor is rotatably connected to the K0 shaft such that the rotor rotates with the engine crankshaft (or rotates the engine crankshaft). When the K0 clutch is disengaged, the rotor is not connected to the K0 shaft (or the crankshaft) and is freely rotatable relative to the engine. The K0 clutch includes piston 120 sealed to the cover at radially inner portion 122 and at radially outer portion 124. K0 clutch 108 also includes clutch plates 126 rotatably connected to the K0 shaft and clutch plates 128 rotatably connected to the rotor. Piston 120 is arranged to compress clutch plates 126 against clutch plates 128 to engage the K0 clutch to rotatably connect the rotor to the K0 shaft.

Cover 114 includes tubular portion 130 and radially inner portion 122 is sealed to the tubular portion via seal 132 disposed in the tubular portion, for example. Although the seal is shown in a groove of the tubular portion, other embodiments are possible. For example, other embodiments (not shown) may include seal 132 in the radially inner portion, for example. As shown in the figure, tubular portion 130 at least partially overlaps at least one of clutch plates 128 in a radial direction. By overlapping in a radial direction, we mean that a line can be drawn that extends from rotational centerline 134 in a radial direction and intersects both the tubular portion and one of clutch plates 128. Similarly, the tubular portion also partially overlaps K0 shaft 106 in a radial direction.

Cover 114 also includes tubular projection 136 and radially outer portion 124 is sealed to the projection via seal 138, for example. Although the seal is shown in a groove of the piston, other embodiments are possible. For example, other embodiments (not shown) may include seal 138 in the tubular projection, for example. As shown in the figure, tubular projection 136 is secured to the cover by welding, but other embodiments are possible. For example, other embodiments (not shown) may include the tubular projection secured to the cover by riveting, or integrally formed with the cover from a same piece of material, for example. Rotor 110 is secured to cover 114 radially outside of the tubular projection. Tubular projection 136 at least partially overlaps clutch plates 126 and 128 in an axial direction. By overlapping in an axial direction, we mean that a line can be drawn that extends parallel to rotational centerline 134 in an axial direction and intersects the tubular projection and the clutch plates.

Hybrid module 100 also includes compensation plate 140 fixed to the cover. Piston 120 is sealed to the compensation plate at seal 142, for example. Although the seal is shown in a groove of the compensation plate, other embodiments are possible. For example, other embodiments (not shown) may include seal 142 in the piston, for example. The compensation plate may be arranged to provide a hydraulic balancing force to piston 120 in a known manner for improved controllability of K0 clutch 108. That is, the compensation plate retains hydraulic fluid in a chamber defined by the piston and the compensation plate to counteract dynamic pressure effects from hydraulic fluid acting on the piston from a chamber defined by the piston and the cover. Hybrid module 100 also includes spring 144 arranged axially between the compensation plate and the piston for urging the piston away from the compensation plate.

Hybrid module 100 also includes reaction plate 146 fixed to the K0 shaft at staked connection 148, for example, and arranged to restrict axial movement of clutch plates 126 and 128 away from the piston. Hybrid module 100 also includes housing 150, rotor flange 152 fixed to rotor 100 and rotatably arranged in the housing, and bearing 154 for rotatably supporting the reaction plate against the rotor flange. As shown in the figure, bearing 154 is an axial needle bearing but other embodiments may include different types of bearings or bushings, for example. Hybrid module 100 also includes bearing 156 for rotatably supporting the rotor flange in the housing. As shown in the figure, bearing 156 is a ball bearing but other embodiments may include different types of bearings or bushings, for example. Hybrid module 100 also includes bearing 158 for rotatably supporting the K0 shaft in the housing. As shown in the figure, bearing 158 is a radial needle bearing but other embodiments may include different types of bearings or bushings, for example.

When the K0 clutch is engaged, bearing 154 operates to support axial forces from the piston against the rotor flange. For example, hydraulic forces acting on the piston urge the piston towards clutch plates 126 and 128 to engage the K0 clutch. Reaction plate 146 provides support to the clutch plates and the rotor flange supports the reaction plate via bearing 154. Because the rotor flange is fixed to the rotor (at staking 160, for example), the rotor restricts axial movement of the rotor flange. The same hydraulic forces acting on the piston also act on the cover in an opposite direction. Since the cover is riveted to the rotor, the forces on the rotor are balanced and contained, limiting forces applied to the housing and/or shafts.

Housing 150 may be arranged for fixing to engine block 162 and transmission housing 164, for example. That is, a transmission housing normally secured to an engine block is spaced apart from the engine block by hybrid module housing 100. During operation, hydraulic oil from the transmission may be used to operate the K0 clutch. The hydraulic oil may be supplied through bore 166 in transmission input shaft 168. Tubular portion 130 includes radial hole 170 aligned with radial hole 172 in the input shaft for receiving the hydraulic oil.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 P2 hybrid module
102 Electric motor
104 Torque converter
106 K0 shaft
108 K0 clutch
110 Rotor (electric motor)
112 Stator (electric motor)
114 Cover (torque converter)
116 Rivets (cover to rotor)
118 Splined portion (K0 shaft)
120 Piston (K0 clutch)
122 Radially inner portion (piston 120)
124 Radially outer portion (piston 120)
126 Clutch plates (first plurality)
128 Clutch plates (second plurality)
130 Tubular portion
132 Seal (tubular portion)
134 Rotational centerline
136 Tubular projection (cover)
138 Seal (piston)
140 Compensation plate
142 Seal (compensation plate)
144 Spring
146 Reaction plate
148 Staked connection (reaction plate to K0 shaft)
150 Housing
152 Rotor flange
154 Bearing (first)
156 Bearing (second)
158 Bearing (third)
160 Staking (rotor flange to rotor)
162 Engine block
164 Transmission housing
166 Bore (input shaft)
168 Transmission input shaft
170 Radial hole (tubular portion)
172 Radial hole (input shaft)

What is claimed is:

1. A hybrid module, comprising:
an electric motor comprising a rotor;
a torque converter arranged for driving engagement with an input shaft of a transmission, the torque converter comprising a cover rotatably connected to the rotor;
a K0 shaft arranged for driving connection to a crankshaft of a combustion engine; and
a K0 clutch arranged for selectively rotatably connecting the rotor to the K0 shaft, the K0 clutch comprising a piston sealed to the cover at a radially inner portion and at a radially outer portion.

2. The hybrid module of claim 1, wherein the K0 clutch further comprises:
a first plurality of clutch plates rotatably connected to the K0 shaft; and
a second plurality of clutch plates rotatably connected to the rotor, wherein the piston is arranged to compress the first plurality of clutch plates against the second plurality of clutch plates to engage the K0 clutch to rotatably connect the rotor to the K0 shaft.

3. The hybrid module of claim 2, wherein:
the cover comprises a tubular portion; and
the radially inner portion is sealed to the tubular portion.

4. The hybrid module of claim 3, wherein the tubular portion at least partially overlaps at least one of the second plurality of clutch plates in a radial direction.

5. The hybrid module of claim 3, wherein the tubular portion at least partially overlaps the K0 shaft in a radial direction.

6. The hybrid module of claim 1, wherein:
the cover comprises a tubular projection; and
the radially outer portion is sealed to the projection.

7. The hybrid module of claim 6, wherein the tubular projection is secured to the cover by welding or riveting.

8. The hybrid module of claim 6, wherein the rotor is secured to the cover radially outside of the tubular projection.

9. The hybrid module of claim 6, wherein the tubular projection at least partially overlaps the first plurality of clutch plates and the second plurality of clutch plates in an axial direction.

10. The hybrid module of claim 1, further comprising a compensation plate fixed to the cover, wherein the piston is sealed to the compensation plate.

11. The hybrid module of claim 10, further comprising a spring arranged axially between the compensation plate and the piston for urging the piston away from the compensation plate.

12. The hybrid module of claim 1, further comprising a reaction plate fixed to the K0 shaft and arranged to restrict axial movement of the first plurality of clutch plates and the second plurality of clutch plates away from the piston.

13. The hybrid module of claim 12, further comprising:
a housing;
a rotor flange fixed to the rotor and rotatably arranged in the housing; and
a first bearing for rotatably supporting the reaction plate against the rotor flange.

14. The hybrid module of claim 13, wherein the first bearing is an axial needle bearing.

15. The hybrid module of claim 13, further comprising a second bearing for rotatably supporting the rotor flange in the housing.

16. The hybrid module of claim 15, wherein the second bearing is a ball bearing.

17. The hybrid module of claim 1, further comprising:
a housing; and
a third bearing for rotatably supporting the K0 shaft in the housing.

18. The hybrid module of claim 17, wherein the third bearing is a radial needle bearing.
